(19) United States
(12) Patent Application Publication
(10) Pub. No.: US 2023/0320273 A1
(43) Pub. Date: Oct. 12, 2023

(54) Crop Stream Analysis System in a Combine Harvester

(71) Applicant: AGCO International GmbH, Neuhausen (CH)

(72) Inventor: Dan Hermann, Randers (DK)

(21) Appl. No.: 18/044,189

(22) PCT Filed: Sep. 27, 2021
(86) PCT No.: PCT/IB2021/058776

§ 371 Date: Mar. 6, 2023

(30) Foreign Application Priority Data
Oct. 31, 2020 (GB) 2017291.2

(51) Int. Cl. A01D 41/127

(52) U.S. Cl. CPC A01D 41/1276; A01F 12/446

(57) ABSTRACT

A combine harvester includes a grain pan that is arranged to catch a crop stream. The grain pan is driven in a fore and aft oscillating manner to convey the crop stream rearwardly across a conveyance surface to a rear edge. The grain pan is provided with an upright panel extending in a fore and aft direction on the conveyance surface. A grain cleaning system is arranged to receive the crop stream from the grain pan. A crop stream analysis system is provided for analysing a vertical section of a crop material layer disposed on the grain pan. The analysis system includes a vertical array of photoelectric sensing devices mounted to the panel. Each photoelectric sensing device is configured to sense a reflectance of crop material disposed against the panel. A processor is configured to receive reflectance signals from the photoelectric sensing devices and determine a material stratification status from the reflectance signals.

### FIELD OF THE INVENTION

The invention relates to combine harvesters and in particular to the analysis of a crop material stream conveyed by a grain pan.

### BACKGROUND OF THE INVENTION

The process for cleaning grain in combine harvesters has not changed fundamentally for many decades. The grain cleaning system, or ‘shoe’, has directed therethrough a cleaning airstream which is typically generated by a cross-flow or centrifugal fan located in front of the cleaning shoe. As a mix of grain kernels, chaff, tailings and straw is passed over one or more oscillating sieves, the cleaning airstream serves to blow the lighter material in a generally rearward direction over the sieves and out of the rear of the machine. The grain is generally heavier and/or smaller than the material other than grain (MOG) in the mix and passes through the sieves.

The cleaning shoe is most efficient when the grain is caused to settle on the uppermost sieve (hereinafter referred to as the chaffer) as early as possible and the lighter material is kept airborne. If the grain bounces on impact with the chaffer then the risk of the cleaning airstream carrying the grain out of the rear of the shoe increases. The speed of the cleaning airstream is typically selected to strike a balance between grain cleanliness and acceptable loss. Ultimately, this balance creates a limit on the capacity of the cleaning unit. In other words, without an increase in shoe size, any increase in capacity will adversely affect grain cleanliness and/or loss rate.

However, despite these limits, there remains a continuing drive to increase the size and capacity of combine harvesters to meet the needs of modern farmers and to speed up the overall harvesting process. As outlined above, increasing the throughput of the cleaning shoe with known technology requires an increase in the physical size. For example, increasing the width of the cleaning shoe would deliver an increased machine capacity but at the cost of increased machine width. However, maximum machine width is limited by road transport legislation in some countries thus rendering this option unattractive. In a similar vein, increasing the length of the chaffer would require an increase in wheel base and a consequential increase in turn radius which is undesirable to farmers.

Efforts to increase the capacity of the cleaning shoe based on pre-stratification of the crop stream have been made. For example, WO-2012/095239, discloses a combine harvester having an extended return pan which catches separated crop material from overhead threshing and separating apparatus and conveys such to a front edge from where it drops on to a grain pan, the grain pan conveying the crop mix rearwardly to a rear edge from where it falls into the cleaning shoe. In this disclosure, the return pan is of an extended construction to deliver the majority of the separated material to the front of the grain pan to facilitate enhanced stratification of the material before delivery to the cleaning shoe. As disclosed therein, the recognised advantage that the grain rich bottom layer falls directly onto the chaffer whereas the upper MOG-rich layer is rendered airborne by the cleaning airstream.

WO-2015/062965, WO-2016/096839, WO-2016/096841 and WO-2016/166016 each disclose further examples of improvements to combine harvesters aimed at improving the stratification of grain and MOG on a grain pan.

Today it is known to provide combines with control systems that automatically adjust settings of the various crop processing apparatus. Such “auto-setting” functionality relieves the operator of making manual adjustments to optimise the harvesting process, wherein the optimum settings continuously change as harvest conditions vary. However, for reliable auto-setting operation an accurate representation of the current conditions within the various processing apparatus is required. Whilst attempts are made to improve the stratification of crop material upstream of the grain cleaning system driven by the aforementioned advantages, any auto-setting control today is ignorant to the degree of material stratification on the grain pan at any given time.

According to a first aspect of the invention there is provided a combine harvester comprising a grain pan arranged to catch a crop stream, the grain pan being driven in a fore and aft oscillating manner to convey the crop stream rearwardly across a conveyance surface to a rear edge. The grain pan is provided with an upright panel extending in a fore and aft direction on the conveyance surface. A grain cleaning system is arranged to receive the crop stream from the grain pan. A crop stream analysis system comprises a vertical array of photoelectric sensing devices mounted to the panel, wherein each photoelectric sensing device is configured to sense a reflectance of crop material disposed against the panel. A processor is configured to receive reflectance signals from the photoelectric sensing devices and determine a material stratification status from the reflectance signals.

The crop stream analysis system advantageously generates a status or indication of the extent of material stratification on the grain pan at a given time. It should be understood that the material stratification status correlates to a measure of order or entropy with respect to the layering of the grain and MOG. In a perfectly stratified crop material layer, a layer of MOG will reside over a layer of grain. Conversely, a crop material layer with no stratification will consist of grain and MOG mixed throughout the depth of the layer.

Knowledge of the extent of material stratification on the grain pan, for example in the form of a numerical value, electrical signal, or a status indice, can be utilised as a control input parameter for automatic control of one or more working units on the combine. In a preferred embodiment, a working unit of the combine harvester is controlled so as to optimise the stratification of the crop material on the grain pan. In one embodiment, the frequency of oscillation at which the grain pan is driven is controlled based upon the material stratification status. For example, a closed-loop control may be used to adjust the grain pan drive frequency to achieve a desired material stratification status.

In one embodiment each photoelectric sensing device comprises a light source and a photodiode. The light source may be an LED.

In another embodiment the panel forms one of a plurality of panels disposed on the conveyance surface. In one example, the panels are spaced apart and serve as crop dividers to restrict lateral movement on crop material on the grain pan, during operation on a side-hill for example. The use of crop dividers is well established and existing crop dividers present a convenient location to mount the photoelectric sensing devices. In an alternative embodiment, the panel may be disposed on a lateral edge of the grain pan.

A portion of the processor may be mounted to the panel, and in a preferred embodiment the processor may be encapsulated together with the photoelectric sensing devices in a self-contained module mounted to the panel. In one embodiment the photoelectric sensing devices and any associated electronic components are encapsulated between a cover and the panel surface. A window may be provided in the cover, overlaying the array of photoelectric devices. In one embodiment, the photoelectric sensing devices, or module encapsulating such, are mounted in a cut-out formed in the panel.

In a preferred embodiment the grain pan is disposed beneath threshing apparatus so as to catch at least a portion of the threshed material falling therefrom. Further crop material may be dropped onto the grain pan from a return pan which catches crop material falling from overhead separating apparatus. The return pan is preferably arranged to convey crop material in a forward direction to a front edge from where the material falls onto the grain pan. The grain pan is preferably operable to stratify the crop material dropped thereon from the threshing and/or separating apparatus.

The reflectance signals may be processing in a number of different ways to determine the material stratification status. In one embodiment, the vertical section is illuminated with light of different colours at different times and the reflectance of each colour is sensed. For some crop types the colour differential between the grain kernels and the MOG is sufficient enough to distinguish between the respective reflectance signals in the different colours and generate a representation of grain and MOG through the layer depth. However, for other crops, cereals for example, the colour differential may not be sufficient to distinguish between grain and MOG using the reflectance signals.

In another embodiment, the reflectance signals are periodically analysed to determine movement of the crop material at different depths, and the stratification status is determined from this movement. Variance, or increased variance, in the reflectance signals may be correlated to movement of the material immediately adjacent the corresponding sensing devices. This aspect of the invention involves the recognition that movement of only the uppermost portion of the material layer thickness likely indicates insufficient agitation to cause the MOG to rise above the grain. Conversely, sensed movement throughout the entire thickness of the material layer likely indicates excessive agitation which causes the grain to rise and mix with the MOG in the upper region.

In accordance with a second aspect of the invention there is provided a method of controlling a combine harvester comprising the steps of:
illuminating and sensing reflectance from a vertical section of a crop material layer disposed on a grain pan in a combine harvester, wherein the grain pan is operable to convey crop material to a grain cleaning system;
generating reflectance signals corresponding to the reflectance at different depths through the crop material layer;
calculating a material stratification status from the reflectance signals; and,
driving the grain pan in a fore and aft oscillating manner at an oscillation frequency that is dependent upon the stratification status.

### BRIEF DESCRIPTION OF THE DRAWINGS

Further advantages of the invention will become apparent from reading the following description of specific embodiments with reference to the appended drawings in which:

FIG. 1 is a schematic side elevation of a combine harvester in accordance with an embodiment of the invention, shown with the side panels removed to reveal the inside processing systems;

FIG. 2 is a schematic side view of a material conveyance system and grain cleaning system embodied in the combine harvester of FIG. 1;

FIG. 3 is a plan view of a grain pan in accordance with an embodiment;

FIG. 4 is a perspective view of the rear part of a grain pan in accordance with an embodiment;

FIG. 5 is horizontal sectional view along the line V-V of FIG. 4 showing an encapsulated photo-sensing module in accordance with an embodiment;

FIG. 6 is a schematic side view of a photo-sensing module utilised in embodiments of the invention;

FIG. 7 is a block diagram of a control system embodied in the combine harvester of FIG. 1;

FIGS. 8A-C illustrate schematically a vertical section through a crop material layer at different stages of rearward conveyance on a grain pan when operating under preferred conditions;

FIGS. 9A and 9B illustrate schematically a vertical section through a crop material layer on a grain pan when operating under suboptimal conditions; and,

FIG. 10 illustrates a method in accordance with an embodiment.

### DETAILED DESCRIPTION OF SPECIFIC EMBODIMENTS OF THE INVENTION

Aspects of the invention will now be described in connection with various preferred embodiments implemented on a combine harvester. Relative terms such as front, rear, forward, rearward, left, right, longitudinal and transverse will be made with reference to the longitudinal vehicle axis of the combine harvester travelling in the normal direction of travel. The terms “direction of conveyance”, “upstream” and “downstream” are made with reference to the general flow of crop material through the combine harvester, or to the cleaning airstream through the screening apparatus.

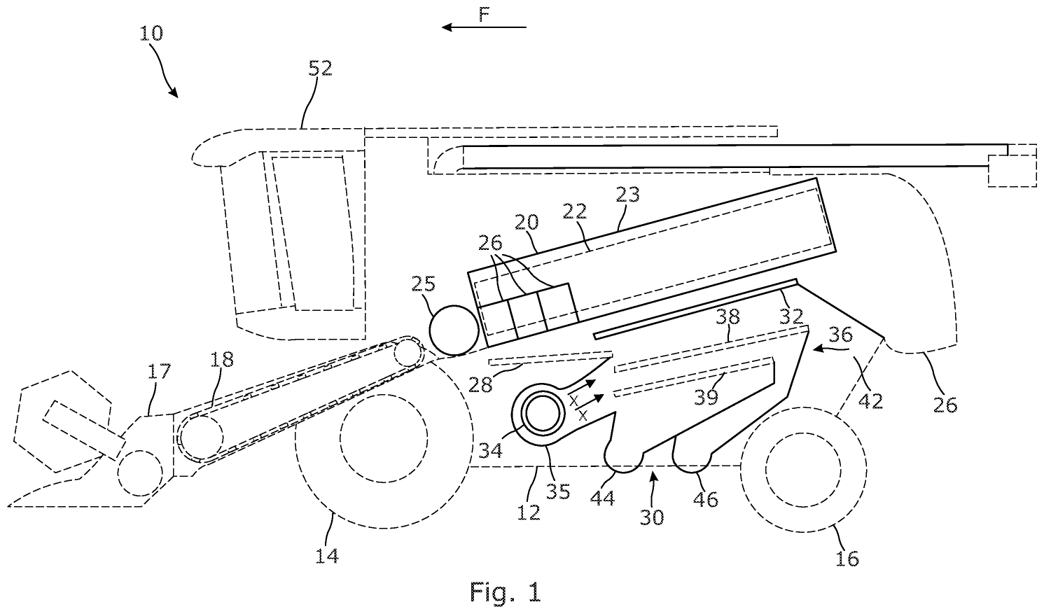

With reference to FIG. 1 a combine harvester 10 includes a frame or chassis 12, front wheels 14 and rear steerable wheels 16. A cutting header 17 is detachably supported on the front of a feederhouse 18 which is pivotable about a transverse axis to lift and lower the header 17 in a conventional manner.

The combine 10 is driven in a forward direction F across a field of standing crop in a known manner. The header 17 serves to cut and gather the crop material before conveying such into feederhouse 18 and elevator 19 housed therein. At this stage the crop stream is unprocessed. It should be understood that combine harvesters are employed to harvest a host of different crops including cereal, rice, beans, corn and grass seed. The following description will make reference to various parts of the cereal crop stream but it should be understood that this is by way of example only and does not by any means limit the applicability of the invention to harvester other crops.

The cut crop stream is conveyed rearwardly from the feederhouse 18 to a processor designated generally at 20. In the illustrated embodiment the processor 20 is of the axial rotary type having a pair of axial-flow threshing and separating rotors 22 which are each housed side-by-side inside a respective rotor housing 23 and are fed at their front end by a feed beater 25. It should be appreciated that the right-hand rotor is hidden from view in FIG. 1. The rotors serve to thresh the crop stream in a front ‘threshing’ region, separate the grain therefrom in a rear ‘separating’ region, and eject the straw residue through the rear of the machine 26 either directly onto the ground in a windrow or via a straw chopper (not shown).

Each rotor housing 23 is generally cylindrical and is made up of an opaque upper section and a foraminous lower section which includes a set of side-by-side arcuate concave grate segments 26 extending the length of the front threshing region and which allow the threshed material to fall by gravity onto a grain pan 28 located below for onward conveyance to a grain cleaning system which is designated generally at 30. Guide vanes (not shown) are secured to the inside of the rotor housing and serve, in conjunction with the crop engaging elements on the rotor 22, to convey the stream of crop material in a generally rearward spiral path from front to rear. The threshing region generally includes a plurality of threshing bars mounted on an adjustable concave, wherein the spacing between the threshing bars and the swept envelope of the rotor is adjustable to adjust the severity of the threshing action.

The separating region at the rear portion of rotors 22 comprises plural crop engaging elements (not shown) to separate the residual grain from the stream of crop material. A grain return pan 32 is provided underneath the separating region to collect the separated grain and convey it forwardly for delivery onto the grain collection pan 28. Both the grain pan 28 and return pan 32 are driven with a drive mechanism so as to oscillate in a known manner.

Although described as a rotary axial type, the processor 20 may be of an alternative type such as known conventional, hybrid or transverse types without departing from the scope of the invention. For example, in the case of a conventional type processor, a transverse cylindrical beater may be provided as threshing apparatus and a set of straw-walkers provided as separating apparatus.

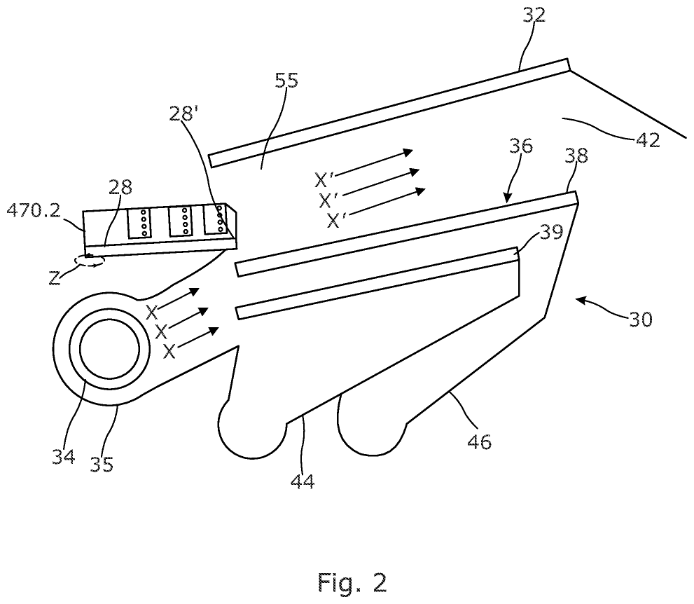

With reference to FIGS. 1 and 2 the grain cleaning system 30 comprises a fan 34 housed in a fan housing 35. The fan 34 may be of a known type such as a crossflow or centrifugal fan that rotates on a transverse axis and draws in air either tangentially or axially through air intake openings. A cleaning airstream generated by the fan 34 and exhausted from the fan housing 35 is represented in FIG. 2 by arrows ‘X’.

The grain cleaning system 30 comprises screening apparatus 36 which includes a shoe frame (not shown), upper sieve 38 (alternatively referenced ‘chaffer’) and a lower sieve 39. The sieves 38, 39 are driven with an oscillating motion in a known manner. The sieves 38, 39 are mounted between side members of the shoe frame which is suspended on hangers (also not shown) from the frame 12 and driven in an oscillating motion.

It should be understood that the return pan 32 may be shorter than shown wherein crop material falls from the front edge direct into the grain cleaning system 30.

The sieves 38, 39 each comprise a plurality of transverse louvres which can be adjusted either manually or remotely to adjust the coarseness of the screen provided. The louvres are arranged in a parallel transverse relationship and pivot to adjust the opening or gap between adjacent ones.

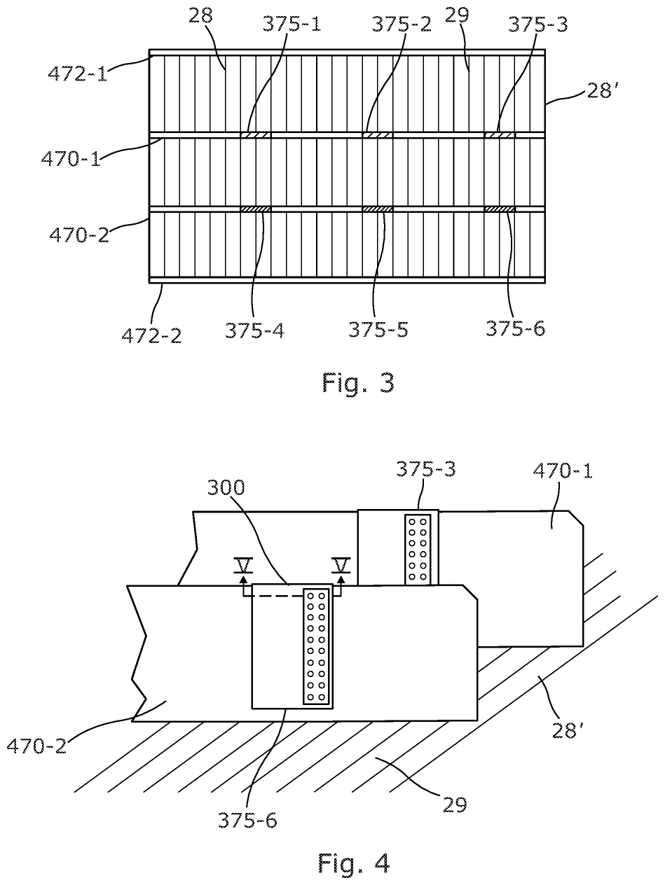

The threshed material, comprising a mixture of grain kernels and MOG, is conveyed by the grain pan 28 in a rearward direction until it falls from a rear edge 28′ and into the grain cleaning system 30. The grain pan 28 is driven by a drive system that imparts a generally elliptical or fore and aft oscillating motion to the grain pan 28 indicated by arrows ‘Z’ in FIG. 2. The grain pan 28 preferably has a ridged conveyance surface 29 shown in FIG. 3, with ridges that extend transversely. Crop material disposed on the grain pan 28 is conveyed generally rearwardly by the oscillating motion in combination with the ridged surface 29.

The grain pan 28 is provided with a plurality of upright crop dividers 470 that extend longitudinally on the surface of the conveyance surface 29 and serve to restrict lateral movement of the crop material when operating in sidehill conditions for example. FIGS. 3 and 4 show two crop dividers 470-1, 470-2 laterally spaced apart and extending for the full length of the grain pan 28. It should be appreciated however that more or less dividers may be provided, and the dividers may extend for only a portion of the length of the grain pan 28. The dividers 470 present an upright structure to restrict the lateral movement of grain and are preferably planar with vertical surfaces.

The grain pan 28 may also be provided with upright panels 472-1, 472-2 at the lateral edges to retain the crop material during conveyance.

Turning back to FIG. 2, the cleaning airstream ‘X’ is directed through and over the sieves 38,39 in a known manner so as to lift the lighter material, primarily MOG, away from the surface of upper sieve 38 and in a rearward direction for ejection at a rear outlet 42.

In a known manner, the screening apparatus 36 is operable to allow the clean grain to pass through the sieves 38, 39, wherein the clean grain is collected in a transverse clean grain trough 44 and conveyed onwards to an on-board grain tank (not shown). The louvres of upper sieve 38 may be set to allow unthreshed heads to pass through a rear region of the upper sieve 38 into a tailings collection trough 46. Likewise, any material screened out by lower sieve 39 falls from the rear edge thereof into the tailings collection trough 46 from where the ‘returns’ are fed back to the processor 20 or a dedicated rethreshing system (not shown).

Working units of the combine harvester 10 are controlled by an electronic controller 101. Adjustments controlled by or via the controller 101 include adjustments to the concave spacing, to the speed of rotors 22, to the speed or frequency of the oscillating drive for the grain pan 28, to the speed of the cleaning fan 34 and to the openings of the sieves 38, 39. With reference to FIG. 7, the controller (hereinafter termed ‘ECU’) 101 is provided and is in communication (via a databus) with an operator console 105, a concave controller 126, a pan drive controller 128, a sieve controller 136, and the fan speed controller 134. The ECU 101 comprise control circuitry 102 which may be embodied as custom made or commercially available processor, a central processing unit or an auxiliary processor among several processors, a semi-conductor based micro-processor (in the form of a micro-chip), a macro processor, one or more applications specific integrated circuits, a plurality of suitably configured digital logic gates, and/or other well-known electrical configurations comprising discrete elements both individually and in various combinations to coordinate the overall operation of the combine 10.

The ECU 101 further comprises memory 103. The memory 103 may include any one of a combination of volatile memory elements and non-volatile memory elements. The memory 103 may store a native operating system, one or more native applications, emulation systems, emulated applications for any of a variety of operating systems and/or emulated hardware platforms, emulated operating systems etc. The memory 103 may be separate from the controller 101 or may be omitted.

The operator console 105 comprises a display 106 which may be integrated as part of a terminal having user interface devices such as buttons, levers and switches. The console 105 is mounted proximate to a drivers work station in cab 52.

The concave controller 126, pan drive controller 128, sieve controller 136, and fan speed controller 134 each serve to control the aforementioned adjustments of respective working units of the combine 10 and may each comprise a local standalone processor and/or memory, or may be integrated into the central ECU 101. Control signals generated by the ECU 101 are communicated to the respective working unit controllers 126,128,136,134 which are then translated into an adjustment of the associated working unit including the concave, grain pan drive, sieves 38, 39 and fan 34.

In accordance with an embodiment a crop stream analysis system 300 is provided to analyse the crop material disposed on the grain pan 28, and specifically a vertical section through a layer of the crop material, and to determine a stratification state of the material. The stratification state is utilised in one example embodiment to control the speed of the grain pan 28 to adjust the severity of the agitation or acceleration imparted upon the crop material so as to optimise stratification and, in turn, allow for increased throughput and/or cleaning effectiveness.

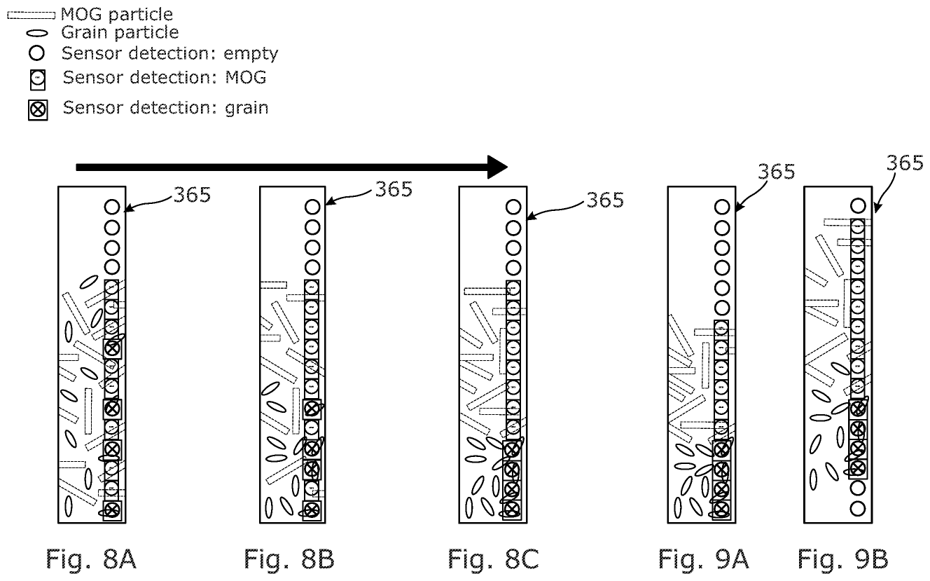

In the illustrated embodiment of FIGS. 3-6, the analysis system 300 comprises a plurality of photo-sensing modules 375 mounted at spaced intervals on the crop dividers 470, three modules 375-1, 375-2, 375-3 spaced apart on the right-hand divider 470-1, and three modules 375-4, 375-5 and 375-6 spaced apart on the left-hand divider 470-2. The modules 375 may be mounted in a respective cut-out of the divider 470. It should be appreciated that more or fewer modules than that shown may be employed. An advantage of providing a plurality of modules 375 at spaced intervals in the direction of conveyance, whether that be two or more, is that a progression of the stratification of the crop material can be monitored as detailed later with reference to FIGS. 8A-C.

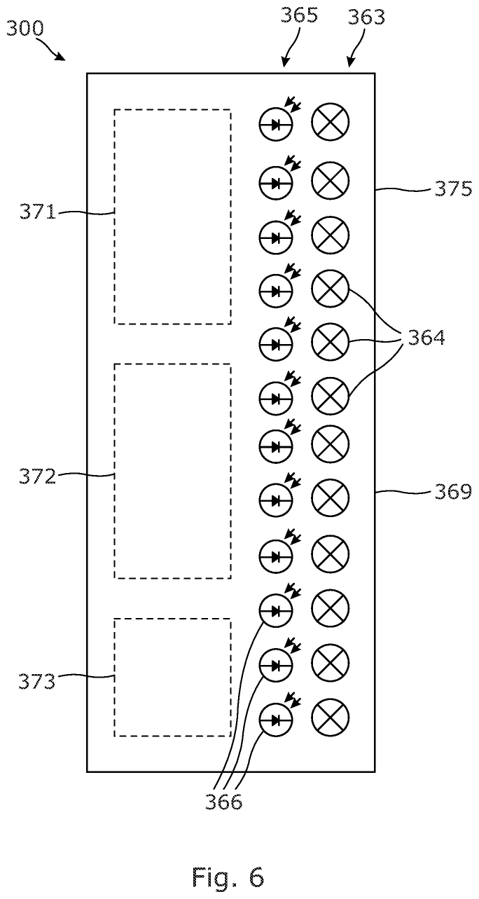

Each photo-sensing module 375 comprises a vertical array 365 of photoelectric sensing devices, each device preferably formed of an individual photodiode 366. FIG. 6 shows twelve photodiodes 366 stacked vertically one above the other, whilst FIG. 4 shows ten photodiodes in a stack and FIG. 2 shows only four. It should be understood that any practical number of photoelectric sensing devices can be employed. The photodiodes 366 in the illustrated embodiment are mounted upon a printed circuit board (PCB) 369 which is, in turn, supported on the crop divider 470. However, it should be understood that other arrangements may serve to mount photoelectric sensing devices on a crop divider 470 or edge panel 472.

Each module 375 further comprises a vertical array 363 of LEDs 364 mounted adjacent the array photoelectric sensing devices 365. The array 363 of LEDs 364 preferably corresponds in number and vertical spacing to the array 365 of photodiodes 366, wherein each photodiode 366 is mounted adjacent a respective LED 364. The LEDs 364 are also preferably mounted to the PCB 369 and serve to illuminate the crop material disposed against the module 375.

More or less LEDs may be employed to illuminate the crop material. In alternative embodiment the LEDs 364 are replaced with alternative light sources which may or may not be mounted to the PCB 369. The LEDs 364 may be bi-colour with the ability to emit two or more colours of light.

A power supply 371 may be mounted to the PCB 369 to allow for wireless communication between the module 375 and the ECU 101, and/or to power a micro-processor 372 also preferably mounted to the PCB 369. An LED driver 373 may be provided to drive the LEDs 364, the driver 364 being mounted to the PCB 369.

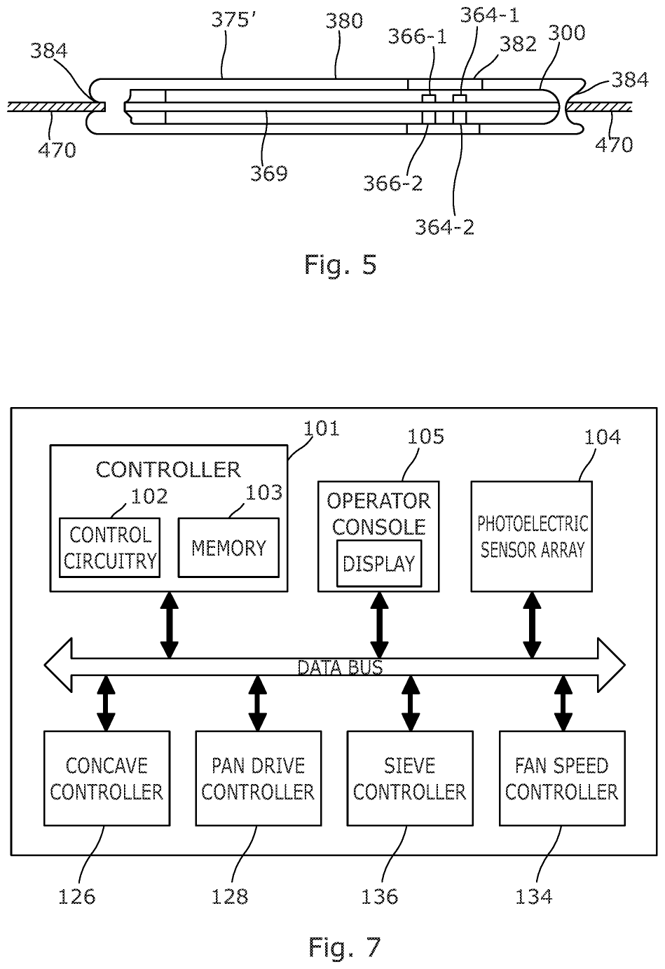

The components mounted to the PCB 369 are preferably encapsulated to prevent ingress of particulate matter into the electronic components and to protect those components from damage. In one embodiment the PCB 369 and components mounted thereto are encapsulated by a cover 380 which is provided with a window 382 overlaying the photodiodes 366 and LEDs 364 as shown in FIG. 5.

The embodiment of FIG. 5 is a two-sided module 375′ in which components are mounted to both sides of the PCB 369, each side being encapsulated by a respective cover 380. The cover 380 is preferably formed from a resilient material and comprises recesses or slots 384 along the fore and aft edges to receive edges of a cut-out portion of the crop divider 470 to which the module 375′ is mounted.

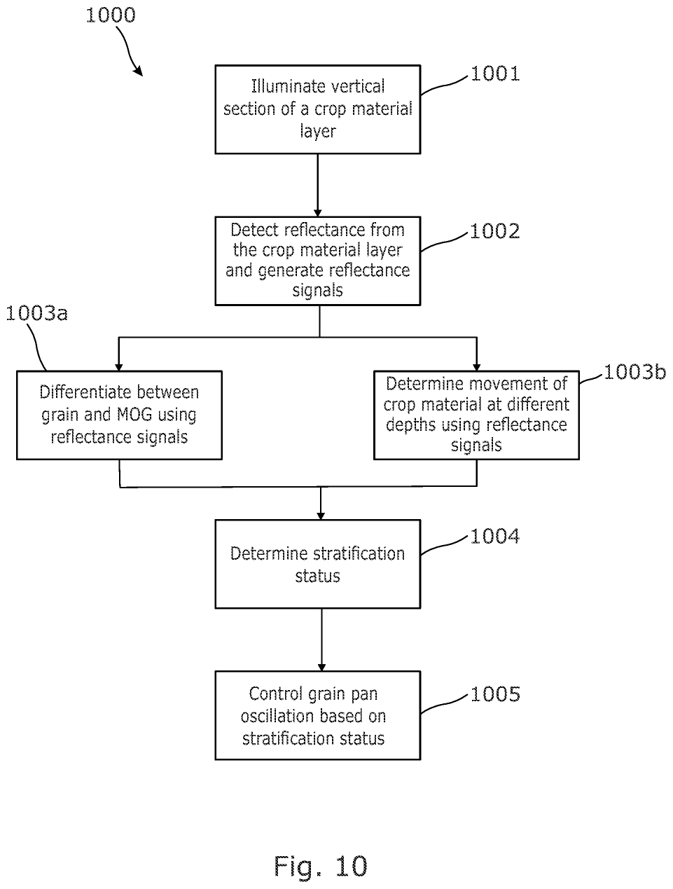

In operation crop material disposed upon the conveyance surface 29 rests up against the crop dividers 470 and thus against the windows 382 of the photo-sensing modules 375. A vertical section through the layer of crop material disposed on the grain pan 28, typically comprising a mixture of grain and MOG, is analysed by the crop stream analysis system 300. In a first step 1001 of a method 1000 according to one embodiment shown in FIG. 10, the crop material is illuminated through the windows 382 by the LEDs 364. The reflected light is detected by the photodiodes 366 in a second step 1002. Reflectance signals, representative of the detected light intensity, are generated by the photodiodes 366.

The reflectance signals are processed by a processor to determine a stratification status of the crop material on the grain pan 28. In some embodiments the reflectance signals are processed by the micro-processor 372 disposed in the module 375. In other embodiments the reflectance signals are processed away from the module 375, for example by the ECU 101. The reflectance signals may be processed in a number of different ways to determine the stratification status. Two example processing methods will now be outlined.

Grain/MOG Differentiation

In a first processing method (step 1003a) the reflectance signals are processed so as to differentiate between grain and MOG. In one embodiment the sample is successively illuminated with light of two or more different colours and the respective reflectance signals are processed to distinguish between grain and MOG. In one example the array of photoelectric sensing devices 365 comprises two light sources, each emitting a different colour, for example red and green. The single array 363 of LEDs 364 may be bi-colour with the ability to illuminate the sample of crop material with light of two different colours. In another example, two arrays of LEDs may be provided wherein each array emits light of a different colour.

The reflectance signals generated by the photodiodes 366 for each respective colour are then processed and an indicator of one of grain, MOG or ‘no material’ is attributed to each reflectance signal. As such a vertical profile or indication of grain and MOG through the layer is obtained.

FIGS. 8A-C each illustrate a representation of grain and MOG within vertical sections at different stages of conveyance on the grain pan 28, showing a preferred or optimum stratification. It should be appreciated that the representations of FIGS. 8A-C may correspond to the fore and aft positions of three photo-sensing modules 375 illustrated in FIGS. 2 and 3. The circles represent a vertical array 365 of sixteen photodiodes with an indicator of either ‘grain’, ‘MOG’ or ‘no material’ shown for each example as determined by the processor.

FIG. 8A shows an example representation of grain and MOG through a vertical profile detected in a front zone of the grain pan 28, for example by module 375-1. It can be observed that grain kernels and MOG are well mixed through the crop layer as one would expect towards the front of the grain pan 28, before much stratification has occurred. FIG. 8B shows an example representation of grain and MOG through a vertical profile detected in a middle zone (with respect to the fore-aft direction) of the grain pan 28, for example by module 375-2. It can be observed that grain kernels and MOG have started to stratify in the material's rearward progression, with grain sinking to the bottom of the layer and MOG rising to the top. FIG. 8C shows an example representation of grain and MOG through a vertical profile detected in a rear zone of the grain pan 28, for example by module 375-3. It can be observed that grain kernels and MOG have effectively stratified with a layer of MOG covering a layer of grain.

It should also be noted that the absence of crop material detected by the top four photodiodes in FIGS. 8A-C provides an indication of the total depth of the crop material layer, and that the depth does not vary in the direction of conveyance.

Still referring to the embodiment of FIG. 10, at step 1004 the stratification status is determined from the reflectance signals. The stratification status may, for example, comprise the series of indices (grain/MOG/no material) corresponding to the reflectance signals and upon which a logical decision can be made regarding the extent of stratification on the grain pan 28.

Detecting Movement of Crop Material

In an alternative processing method (step 1003b) the reflectance signals are periodically analysed to determine movement of the crop material at different depths, wherein the stratification status is determined from said movement. By comparing successive reflectance signals received from a photodiode at a known depth, in which crop material may be determined as being present or absent immediately adjacent the photodiode, movement of the crop material at that depth can be determined irrespective of whether that material be grain or MOG. In one embodiment the degree of variance in the reflectance signal is correlated with movement of the material at the corresponding depth.

FIG. 9A shows an example representation of grain and MOG through a vertical profile detected by a vertical array of photodiodes wherein the grain and MOG, although stratified with the MOG residing above the grain, the material layer is observed to have consolidated with respect to that shown in FIG. 8C for example. This is often caused by the grain pan oscillation being too slow, wherein the upper region of the material layer is not moving or being agitated enough resulting in the MOG not being lifted.

FIG. 9B shows the opposite scenario to that of FIG. 9A wherein the entire crop material layer is observed as moving to the extent that a status of ‘no material’ is observed by the lowermost photodiodes, and material is observed by the uppermost photodiodes. Such an observation is often caused by the grain pan oscillation being too fast which also prevents stratification because the grain kernels are prevented from settling on the conveyance surface 29.

In a fifth step 1005, the grain pan 28 is controlled based upon the stratification status. For example, the speed of oscillation of the grain pan 28 may be optimised in a closed-loop feedback algorithm using the stratification status as an input parameter, wherein MOG is observed to lift and grain observed to segregate on the bottom. The control signals generated in response to the control algorithm are communicated to the pan drive controller 128 for example.

In summary there is provided a combine harvester includes a grain pan that is arranged to catch a crop stream. The grain pan is driven in a fore and aft oscillating manner to convey the crop stream rearwardly across a conveyance surface to a rear edge. The grain pan is provided with an upright panel extending in a fore and aft direction on the conveyance surface. A grain cleaning system is arranged to receive the crop stream from the grain pan. A crop stream analysis system is provided for analysing a vertical section of a crop material layer disposed on the grain pan. The analysis system includes a vertical array of photoelectric sensing devices mounted to the panel. Each photoelectric sensing device is configured to sense a reflectance of crop material disposed against the panel. A processor is configured to receive reflectance signals from the photoelectric sensing devices and determine a material stratification status from the reflectance signals.

All references cited herein are incorporated herein in their entireties. If there is a conflict between definitions herein and in an incorporated reference, the definition herein shall control.

From reading the present disclosure, other modification will be apparent to persons skilled in the art. Such modifications may involve other features which are already known in the field of combine harvesters, component parts, and automatic setting systems therefore, and which may be used instead of or in addition to features already described herein.

1. A combine harvester comprising:
a grain pan arranged to catch a crop stream, the grain pan being driven in an fore and aft oscillating manner to convey the crop stream rearwardly across a conveyance surface to a rear edge, the grain pan being provided with an upright panel extending in a fore and aft direction on the conveyance surface;
a grain cleaning system arranged to receive the crop stream from the grain pan; and,
a crop stream analysis system comprising:
a vertical array of photoelectric sensing devices mounted to the panel, wherein each photoelectric sensing device is configured to sense a reflectance of crop material disposed against the panel; and,
a processor configured to receive reflectance signals from the photoelectric sensing devices and determine a material stratification status from the reflectance signals.

2. A combine harvester according to claim 1, wherein each photoelectric sensing device comprises a photodiode.

3. A combine harvester according to claim 1, wherein the crop stream analysis system further comprises a light source.

4. A combine harvester according to claim 3, wherein the light source comprises a vertical array of LEDs adjacent the photoelectric sensing devices.

5. A combine harvester according to claim 1, wherein panel forms one of a plurality of crop material dividers disposed away from lateral edges of the conveyance surface.

6. A combine harvester according to claim 1, wherein at least a portion of the processor is mounted to the panel.

7. A combine harvester according to claim 6, wherein the array of photoelectric sensing devices and processor are encapsulated between a cover and the panel.

8. A combine harvester according to claim 7, wherein the cover comprises a window overlaying the array of photoelectric sensing devices.

9. A combine harvester according to claim 1, wherein the array of photoelectric sensing devices is mounted in a cut-out region of the panel.

10. A combine harvester according to claim 1, further comprising threshing apparatus and separating apparatus located upstream of the grain pan with respect to a crop material flow.

11. A combine harvester according to claim 10, wherein the threshing apparatus are disposed above the grain pan, and wherein at least a portion of threshed crop material falls onto the grain pan.

12. A combine harvester according to claim 10, further comprising a return pan positioned below the separating apparatus and serving to catch crop material that falls from the separating apparatus and convey said material in a forward direction to a front edge of the return pan from where said material falls under gravity onto the grain pan.

13. A combine harvester according to claim 1, wherein the grain pan is driven at an oscillation frequency that is dependent upon the stratification status.

14. A combine harvester according to claim 1, wherein the array of photoelectric sensing devices comprises two light sources, each emitting a different colour, and wherein the array is configured to sense reflectance for each of the two different colours.

15. A combine harvester according to claim 1, wherein the processor is configured to periodically analyse the reflectance signals to determine movement of the crop material at different depths, and wherein the stratification status is determined from said movement.

16. A combine harvester according to claim 15, wherein said periodic analysis includes correlating a degree of variance in the reflectance signals at respective depths to movement of the crop material at that depth.

17. A method of controlling a combine harvester comprising the steps of:
illuminating and sensing reflectance from a vertical section of a crop material layer disposed on a grain pan in a combine harvester, wherein the grain pan is operable to convey crop material to a grain cleaning system;
generating reflectance signals corresponding to the reflectance at different depths through the crop material layer;
calculating a material stratification status from the reflectance signals; and,
driving the grain pan in a fore and aft oscillating manner at an oscillation frequency that is dependent upon the stratification status.

18. A method according to claim 17, comprising:
illuminating the vertical section with light of different colours at different times,
sensing the reflectance for each of the different colours; and,
from the reflectance signals differentiating between grain and material other than grain in the crop material layer.

19. A method according to claim 17, comprising:
periodically analysing the reflectance signals to determine movement of the crop material at different depths; and,
calculating the material stratification status from said movement.

20. A method according to claim 19, wherein said periodic analysis includes correlating a degree of variance in the reflectance signals at respective depths to movement of the crop material at that depth.
